(19) United States
(12) Patent Application Publication
(10) Pub. No.: US 2010/0068423 A1
(43) Pub. Date: Mar. 18, 2010

(54) SINGLE COMPONENT MOISTURE-CURE POLYURETHANE ADHESIVE FOR SYNTHETIC TURF INSTALLATIONS

(76) Inventors: Abul Hashem Molla, Troy, MI (US); William J. Dunn, Scituate, MA (US); Frederick P. Walnut, North Attleborough, MA (US)

Correspondence Address: WHYTE HIRSCHBOECK DUDEK S.C.;INTELLECTUAL PROPERTY DEPARTMENT, 555 E. WELLS ST., SUITE 1900, MILWAUKEE, WI, 53202, US

(21) Appl. No.: 12/507,492

(22) Filed: Jul. 22, 2009

Related U.S. Application Data
(60) Provisional application No. 61/096,895, filed on Sep. 15, 2008.

(51) Int. Cl. A41G 1/00; C08G 18/32; B32B 37/12

(52) U.S. Cl. 428/17; 528/85; 156/331.7

(57) ABSTRACT

An artificial turf structure comprises

a top layer comprising at least two pieces of artificial turf material, the pieces positioned contiguous to each other to form a seam between the pieces; a substrate underlying the top layer; and a high solids single component moisture cure polyurethane adhesive applied between the top layer and the substrate, wherein the adhesive comprises either:

A. a reaction product of isocyanates, polyols, catalyst and defoamers having a viscosity of the said reaction product in the range of 2,000 to 30,000 cps, and having water-(moisture) reactive free-isocyanate content of 5.2 to 9.2% by weight based on 100% by weight of said reaction product, or

B. a reaction product of isocyanates, polyols, catalyst, defoamers and thixotropic agents having a viscosity of the said thixotropic reaction product in the range of 30,000 to 900,000 cps and having water-(moisture) reactive free-isocyanate content of 3.8 to 7.8% by weight based on 100% by weight of said reaction product.

### CROSS REFERENCE TO RELATED APPLICATION

This application claims the benefit of pending U.S. provisional application Ser. No. 61/096,895 filed on Sep. 15, 2008, the entire disclosure of which is incorporated herein by reference.

### FIELD OF THE INVENTION

The present invention relates to polyurethane based adhesives, more specifically to single-component moisture-curable adhesives and uses for such adhesives.

### BACKGROUND OF THE INVENTION

Synthetic turf field are becoming widely popular throughout North America. Turf fields have a life of between 8 to 12 years. Synthetic fields are becoming revenue producers because of the year round events that can be held on them. Pay back on the synthetic fields is usually from 4 to 6 years, in terms of water, chemicals, and labor for upkeep on natural fields.

Current technology for installation of synthetic turf seams is by sewing the seams, or using an adhesive. The adhesive in use is polyurethane with a flammable solvent. The fugitive solvent is used to achieve the grab tack necessary to hold the synthetic turf to the substrate. The incumbent adhesive has several inherent disadvantages, including: extreme flammability, low flash point, an offensive odor, and a requirement to wait for the solvent to evaporate prior to mating the two substrates.

### BRIEF SUMMARY OF THE INVENTION

In at least some embodiments, the present invention relates to an artificial turf structure that comprises a top layer comprising at least two pieces of artificial turf material, the pieces positioned contiguous to each other to form a seam between the pieces; a substrate underlying the top layer; and a high solids single component moisture cure polyurethane adhesive applied between the top layer and the substrate, wherein the adhesive comprises either:

A. a reaction product of isocyanates, polyols, catalyst and defoamers having a viscosity of the said reaction product in the range of 2,000 to 30,000 cps, and having water-(moisture) reactive free-isocyanate content of 5.2 to 9.2% by weight based on 100% by weight of said reaction product, or

B. a reaction product of isocyanates, polyols, catalyst, defoamers and thixotropic agents having a viscosity of the said thixotropic reaction product in the range of 30,000 to 900,000 cps and having water-(moisture) reactive free-isocyanate content of 3.8 to 7.8% by weight based on 100% by weight of said reaction product.

### DETAILED DESCRIPTION OF THE PREFERRED EMBODIMENT

The invention is an improved method of forming an artificial turf by attaching an artificial turf material to a substrate. A single component moisture-curable polyurethane adhesive is used to bind the seams of the turf material together and also bind the material to the substrate.

The polyurethane adhesive comprises the reaction product of isocyanates and polyols, typically also including catalysts and defoamers. The single component moisture-cure polyurethane adhesive typically has a water (moisture) reactive isocyanate content of 5%-10% by weight, preferably 5.2 to 9.2% by weight, based on 100% by weight of adhesive. The single component polyurethane adhesive has no flammable solvents, no fugitive solvents, and is 100% solids.

The isocyanates are selected from a group having the free isocyanate in the range of 29.0 to 33.5% by weight of isocyanate and having the number average molecular weight of isocyanates in the range of 250 gram/mole to 360 gram/mole.

The polyols may comprise either di-functional or tri-functional alcohols, or a combination of such alcohols, having molecular weight in the range of 62 to 150 gram/mole. The polyols may also comprise high molecular weight diols or triols or quatrol or combinations thereof, having the isocyanate-reactive hydroxyl number in the range of 28 to 250 mg KOH/gram and consequently having the number average molecular weight of the polyols in the range of 450 gram/mole to 4000 gram/mole. Suitable polyols include polyester polyols and polyether polyols, for example polyethylene glycol and polypropylene glycol.

The catalysts consist of either metal catalysts or tertiary amines or isocyanate-reactive hydroxyl-containing tertiary amines or combination of them. Known catalysts include dimorpholinodiethyl ether, N-methyl morpholine, N-ethyl morpholine and N,N,N′,N′-tetramethyl-2,2′-oxybis(ethylamine).

Defoamers are known and can readily be selected by one skilled in the art. In some embodiments, the defoamers comprise a polymethylsiloxane.

In one embodiment, the adhesive comprises a reaction product having a viscosity in the range of 2,000 to 30,000 cps, and having water-(moisture) reactive free-isocyanate content of based on 100% by weight of said reaction product. In another embodiment, the adhesive has a higher viscosity obtained by adding thickeners. In some preferred embodiments, the thickeners impart a thixotropic flow property to the adhesive. Thixotropic thickening agents can comprise either non-reactive polyamide powder of particle size less the 30 microns (according to manufacturer's technical data sheet) or surface treated amorphous fume silica or combination of both. Such thickening agents are known in the art.

In some embodiments, adhesives comprising a thixotropic reaction product have a viscosity in the range of 30,000 to 900,000 cps. Due at least partially to the dilution effect of the thickeners, such adhesives may have water-(moisture) reactive free-isocyanate content of 3.8 to 7.8% by weight based on 100% by weight of said reaction product.

Fillers or colorants may optionally be incorporated into the adhesive. Such fillers include carbonates, more particularly calcium carbonate, and silicates, especially talcum, clay and mica, and sulfates, more particularly calcium and barium sulfate, and aluminum hydroxide, glass and carbon blacks. Besides these inorganic materials, organic materials may also be used, including for example wood, bark or cereal flour and cellulose, pulp or rice shell powder or powder-form cotton linters or synthetic fibers, for example of polyethylene or polyacrylonitrile.

In particularly preferred embodiments, the adhesive is high-solid, preferably 100% solids. High solids means that the adhesive is substantially free of solvents, especially volatile solvents. One embodiment of the invention is a single component, moisture-cure polyurethane adhesive consisting of 100% reactive ingredients, which eliminates fugitive solvents. The high solid nature of the adhesive provides for a non-flammable, single component polyurethane adhesive for synthetic turf.

The inventive adhesive for artificial turf has several advantages; it is non-flammable, its flash point is >400° F., it has no odor, it is 100% solids, it does not require waiting about fifteen minutes to mate the substrates.

Other advantages of the high solid adhesive is that this adhesive meets certain standards for “green” or “environmentally friendly” products. These “green” aspects include: low odor, low VOC (meets SCAQMD rule 1168 for VOC content), and low emissions (meets Greenguard criteria for low emitting products), etc.

The polyurethane turf adhesive may be prepared by any suitable method known in the art. One such method comprises:
(i) adding in the order of isocyanate, polyols, catalyst, and defoamer and, optionally, thixotropic agent while mixing in an inert atmosphere;
(ii) carrying out the reaction with no-external heat but carrying out with its own exothermic heat generated by the reaction of NCO groups with hydroxyl groups of polyols;
(iii) continuing mixing until the content of actual free NCO match to the content of theoretical NCO measured by back titration with dibutyl amine; and,
(iv) degassing the reaction mixture under vacuum up to 25 inch Hg for about 20 minutes.

The polyurethane adhesive can be applied onto a seam underlayment with a trowel, spray equipment utilizing a pump, hose and spray gun, or dispensing equipment such as a “glue box”. The adhesive is applied similarly to the solvent-based adhesive. The polyurethane turf adhesive has an open or work time of 20-25 minutes at relative humidity of around 50% and at ambient temperature, and a final cure time of 24 hours.

### EXAMPLES

Greenguard Testing Description.

GREENGUARD Allowable Emission Levels.

All products are tested in dynamic environmental chambers following the GREENGUARD test method, “Method for Measuring Various Chemical Emissions using Dynamic Environmental Chambers,” as posted on this web site. The method follows the guidance of ASTM standards D-5116-06 and D-6670-01, the U.S. Environmental Protection Agency's testing protocol for furniture, the State of Washington's protocol for interior furnishings and construction materials, and California's DHS standard practice for the Special Environmental Requirements, Specification Section 01350. Products are measured for emission levels, which must meet the following indoor air concentrations within seven (7) days of unpackaging.

Air concentrations are based on the product being in a room 32 m3 in volume with outdoor air ventilation based on ASHRAE 62.1-2007 or the USEPA's recommended exposure factors. Maximum allowable emission levels are those required by the State of Washington's indoor air quality program for new construction, the US Environmental Protection Agency's procurements specifications, the recommendations from the World Health Organization, Germany's Blue Angel Program for electronic equipment, LEED for New Construction, and LEED for Commercial Interiors. Office furniture products meeting these allowable emission levels also meet the requirements of LEED credit 4.5 and the BIFMA X7.1 Conformance standard. When multiple emission values are recommended, the lesser, or more stringent, is used as the acceptable emission value for GREENGUARD Certification.

### Examples 1 and 2

A 100% solids single component adhesive as described above was used to prepare to test artificial turfs. There were two types of synthetic turf tested. Example 1 was an athletic field turf. The turf has a polyurethane backing on it. The two turf pieces were approximately 3′×10′ each. The turf has drain holes every four inches to let water drain off the field. The strip of underlayment was 15″×12′. The underlayment has a sealant on its back side to keep the adhesive from oozing through.

Example 2 was artificial turf for a putting green. This turf had a shorter nap than the field turf of Example 1. It also had a polyurethane backing on it. The same kind of underlayment was used.

The adhesive was applied by pouring out of the can onto the underlayment. The adhesive was troweled around the underlayment with a standard 3/16″ slotted trowel. About 13″ of the 15″ width was covered. The film thickness appeared to be about 4 to 6 wet mils.

The “Dry Time” is the elapsed time since the adhesive was applied to the substrates. The “Pull Time” is the elapsed time since the adhesive was applied and the substrates were pulled apart. All samples were walked on after the substrates were mated. The putting green turf had a 40 pound sandbag placed over it.

| | | DRY | PULL | |
|---|---|---|---|---|
| SAMPLE | EQUIPMENT | TIME | TIME | OBSERVATIONS |
| Field Turf | Trowel | 15 min | 37 min | Pulled apart easily. |
| | | | | Legs were just |
| | | | | forming at 37 |
| | | | | minutes. No grab |
| | | | | tack or green |
| | | | | strength. |
| Field Turf | Trowel | 15 min | 24 hrs | Strong bond. |
| | | | | Could not pull |
| | | | | apart. |
| Putting Green | Trowel | 15 min | 25 min | Had developed |
| | | | | some legs. |
| | | | | Very little green |
| | | | | strength. |
| Putting Green | Trowel | 15 min | 24 hrs | Strong bond. |
| | | | | Could not |
| | | | | pull apart. |

No odor was observed with the test adhesive. The adhesive was accepted because of its 24 hour pull strength and negligible odor.

It is specifically intended that the present invention not be limited to the embodiments and illustrations contained herein, but include modified forms of those embodiments including portions of the embodiments and combinations of elements of different embodiments as come within the scope of the following claims.

1. An artificial turf structure comprising:
a top layer comprising at least two pieces of artificial turf material, the pieces positioned contiguous to each other to form a seam between the pieces;
a substrate underlying the top layer; and
a high solids single component moisture cure polyurethane adhesive applied between the top layer and the substrate,
wherein the adhesive comprises either:
A. a reaction product of isocyanates, polyols, catalyst and defoamers having a viscosity of the said reaction product in the range of 2,000 to 30,000 cps, and having water-(moisture) reactive free-isocyanate content of 5.2 to 9.2% by weight based on 100% by weight of said reaction product, or
B. a reaction product of isocyanates, polyols, catalyst, defoamers and thixotropic agents having a viscosity of the said thixotropic reaction product in the range of 30,000 to 900,000 cps and having water-(moisture) reactive free-isocyanate content of 3.8 to 7.8% by weight based on 100% by weight of said reaction product.

2. The structure of claim 1, wherein the isocyanates have a free isocyanate in the range of 29.0 to 33.5% by weight of isocyanate and have a number average molecular weight of isocyanates in the range of 250 gram/mole to 360 gram/mole.

3. The structure of claim 1 wherein the polyols comprise: (a) either di-functional or tri-functional crosslinkers, or combination thereof, having molecular weight in the range of 62 to 150 gram/mole, and/or (b) high molecular weight diols or trials or quatrol, or combinations thereof, having the isocyanate-reactive hydroxyl number in the range of 28 to 250 mg KOH/gram and having a number average molecular weight of the polyols of claim 1 are in the range of 450 gram/mole to 4000 gram/mole.

4. The structure of claim 1 in which the catalysts comprise at least one of metal catalysts, tertiary amines or isocyanate-reactive hydroxyl-containing tertiary amines.

5. The structure of claim 1 in which the defoamer comprises polymethylsiloxane.

6. The structure of claim 1 wherein the thixotropic agents in 1B comprise either non-reactive polyamide powder of particle size less the 30 microns or surface treated amorphous fume silica or combination.

7. The structure of claim 1 in which the polyurethane turf adhesive has a water (moisture) reactive free isocyanate content in the range of 3.8% to 9.28% by weight based on 100% by weight of said adhesive.

8. The structure of claim 1 wherein the polyurethane turf adhesive has thixotropic properties.

9. The structure of claim 1 wherein the adhesive has an open or work time of 20-25 minutes at relative humidity of around 50% and at ambient temperature, and a final cure time of 24 hours.

10. The structure of claim 1 wherein the adhesive is substantially void of flammable solvents.

11. The structure of claim 1 wherein the adhesive is substantially void of fugitive solvents.

12. The structure of claim 1 wherein the adhesive is substantially void of plasticizers.

13. The structure of claim 1 wherein the adhesive meets SCAQMD VOC requirement of less then 50 g/L as measured by EPA method 24.

14. The structure of claim 1 wherein the adhesive meets Greenguard requirements for low emitting materials as measured by Greenguard's Method for Measuring Various Chemical Emissions using Dynamic Environmental Chambers.

15. The structure of claim 1 wherein the adhesive comprises 100% reactive ingredient solids.

16. A method of producing a polyurethane turf adhesive, comprising:
(i) adding in the order of isocyanate, polyols, catalyst, and defoamer and in presence or absence of thixotropic agent while mixing in an inert atmosphere;
(ii) carrying out the reaction with no-external heat but carrying out with its own exothermic heat generated by the reaction of NCO groups with hydroxyl groups of polyols;
(iii) continuing mixing until the content of actual free NCO match to the content of theoretical NCO measured by back titration with dibutyl amine; and,
degassing the reaction mixture under vacuum up to 25 inch Hg for about 20 minutes,
wherein the adhesive comprises either:
A. a reaction product of isocyanates, polyols, catalyst and defoamers having a viscosity of the said reaction product in the range of 2,000 to 30,000 cps, and having water-(moisture) reactive free-isocyanate content of 5.2 to 9.2% by weight based on 100% by weight of said reaction product, or
B. a reaction product of isocyanates, polyols, catalyst, defoamers and thixotropic agents having a viscosity of the said thixotropic reaction product in the range of 30,000 to 900,000 cps and having water-(moisture) reactive free-isocyanate content of 3.8 to 7.8% by weight based on 100% by weight of said reaction product.

17. A method for making an artificial turf surface, comprising:
positioning at least two pieces of artificial turf material over a substrate, the pieces positioned contiguous to each other to form a seam between the pieces; and
applying a high solids single component moisture cure polyurethane adhesive between the pieces and the substrate at the seam,
wherein the adhesive comprises either:
A. a reaction product of isocyanates, polyols, catalyst and defoamers having a viscosity of the said reaction product in the range of 2,000 to 30,000 cps, and having water-(moisture) reactive free-isocyanate content of 5.2 to 9.2% by weight based on 100% by weight of said reaction product, or
B. a reaction product of isocyanates, polyols, catalyst, defoamers and thixotropic agents having a viscosity of the said thixotropic reaction product in the range of 30,000 to 900,000 cps and having water-(moisture) reactive free-isocyanate content of 3.8 to 7.8% by weight based on 100% by weight of said reaction product.
